(19) United States
(12) Patent Application Publication
(10) Pub. No.: US 2013/0215930 A1
(43) Pub. Date: Aug. 22, 2013

(54) TEMPERATURE MEASUREMENT SYSTEM AND TEMPERATURE MEASUREMENT METHOD

(71) Applicant: FUJITSU LIMITED, (US)

(72) Inventors: Takeo KASAJIMA, Machida (JP); Kazushi UNO, Atsugi (JP); Minoru ISHINABE, Atsugi (JP); Kyouko TADAKI, Atsugi (JP); Fumio TAKEI, Isehara (JP)

(73) Assignee: FUJITSU LIMITED, Kawasaki-shi (JP)

(21) Appl. No.: 13/847,580

(22) Filed: Mar. 20, 2013

Related U.S. Application Data
(63) Continuation of application No. PCT/JP2010/069329, filed on Oct. 29, 2010.

(51) Int. Cl. G01K 11/32

(52) U.S. Cl. CPC G01K 11/32
USPC 374/161

(57) ABSTRACT

To measure the temperature in a temperature-measurement target disposed in a first area, an optical fiber is drawn to the first area from a second area having an adjusted temperature, and the optical fiber is installed in the temperature-measurement target. Furthermore, a reference temperature-measurement unit is provided in the second area. A temperature measurement apparatus detects backscattered light generated in the optical fiber, and detects temperatures at multiple measurement points along an installation path of the optical fiber. When making a correction on a signal outputted from the temperature measurement apparatus, a signal processor replaces temperatures at measurement points located in the second area among the measurement points with a temperature at the reference temperature-measurement unit.

### CROSS-REFERENCE TO RELATED APPLICATION

This application is a continuation of International Patent Application No. PCT/JP2010/069329 filed Oct. 29, 2010 and designated the U.S., the entire contents of which are incorporated herein by reference.

### FIELD

The embodiments discussed herein are related to a temperature measurement system and a temperature measurement method.

### BACKGROUND

At a recent stage of the advanced information society, a computer processes a large amount of data, and a large number of such computers are often installed in the same room for collective management in a facility such as a data center. In such a circumstance, each computer generates a large amount of heat, which may cause malfunction or failure. For this reason, means for cooling the computer is used. Hence, normally in a data center, heat generated in a computer is discharged out of the computer with a fan, while the room temperature is adjusted using an air conditioner.

Meanwhile, the amount of heat generated from a computer varies depending on the operating state of the computer. In order to prevent malfunction and failure of computers due to heat, it is conceivable, for example, to use an air conditioner having a cooling capacity corresponding to the maximum amount of heat generated from computers and operate the air conditioner at its maximum capacity constantly. However, operating an air conditioner having a large cooling capacity at its maximum capacity constantly is not preferable from the viewpoints of not only high running cost but also energy saving and CO₂ reduction. Thus, it is desired to efficiently control an air conditioning system depending on the amount of heat generated from each rack.

In order to efficiently control an air conditioning system, the temperature of each rack installed in a data center is preferably to be measured in real time. Heretofore, the use of an optical fiber as a thermosensor has been proposed for measuring a temperature distribution in an area having multiple heat sources, such as in a data center.
Patent Document 1: Japanese Laid-open Patent Publication No. 2010-107279
Patent Document 2: Japanese Laid-open Patent Publication No. 2004-28748

However, since an optical fiber used as a thermosensor has a low position resolution, it is difficult to precisely and efficiently measure a temperature distribution at a site where temperature measurement spots (measurement points) are densely located.

### SUMMARY

An aspect of the disclosed technology provides a temperature measurement system including: a first area having multiple temperature-measurement targets; a second area demarcated from the first area; an optical fiber installed in such a manner as to be drawn from the second area to the first area for each of the temperature-measurement targets and to pass through the temperature-measurement targets; a temperature measurement apparatus having a light source and configured to acquire temperatures at multiple measurement points along an installation path of the optical fiber by detecting backscattered light generated when light emitted from the light source passes through the optical fiber; and a signal processor configured to correct the temperatures at the measurement points acquired by the temperature measurement apparatus. The optical fiber has a reference temperature-measurement unit disposed in the second area to measure a temperature in the second area. When making the correction, the signal processor replaces the temperatures at the measurement points located in the second area with the temperature at the reference temperature-measurement unit.

Another aspect of the disclosed technology provides a temperature measurement method of measuring temperatures of multiple temperature-measurement targets disposed in a first area, the temperature measurement method including: installing an optical fiber in such a manner that the optical fiber is drawn from a second area having an adjusted temperature to the first area for each of the temperature-measurement targets and passes through the temperature-measurement targets, and disposing a portion of the optical fiber in the second area by a predetermined length and setting the portion as a reference temperature-measurement unit configured to measure a temperature of the second area; acquiring a measured temperature distribution by emitting light into the optical fiber, and detecting backscattered light generated in the optical fiber to detect temperatures at multiple measurement points along an installation path of the optical fiber; and correcting the measured temperature distribution multiple times, and replacing the temperatures at the measurement points in the second area with the temperature at the reference temperature-measurement unit when the correction is made.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1 is a schematic drawing for illustrating an example of a computer room;

FIG. 2 is a schematic drawing for illustrating a state where computers are housed in a rack;

FIG. 3 is a schematic sectional view for describing a method of measuring a temperature distribution using an optical fiber as a thermosensor;

FIG. 4 is an explanatory diagram for describing a temperature measurement system using the optical fiber;

FIG. 5 is a diagram for exemplifying a spectrum of backscattered light generated in the optical fiber;

FIG. 6 is a diagram for illustrating an example of a time series distribution of the intensities of Raman scattered light;

FIG. 7 is a diagram obtained by calculating an I₁/I₂ ratio for each time on the basis of the time series distribution of the intensities of the Raman scattered light in FIG. 6;

FIG. 8 is a diagram for exemplifying a relation between an actual temperature distribution and a temperature distribution (measured temperature distribution) outputted from a temperature measurement apparatus;

FIG. 9 is a diagram for illustrating a transfer function of the temperature measurement system, which is obtainable from a stepped actual temperature distribution in FIG. 8;

FIG. 10 is a diagram for illustrating a function obtained by subjecting the transfer function to Fourier transformation;

FIG. 11 is a diagram for illustrating a measured temperature distribution acquired by measuring an actual temperature distribution, in which the temperature changes at a relatively high spatial frequency, by use of the temperature measurement apparatus;

FIG. 12 is a diagram for exemplifying an inverse filter used in correcting a temperature distribution;

FIG. 13 is a diagram for exemplifying a corrected temperature distribution acquired by causing the inverse filter to act on the measured temperature distribution, thereby correcting this measured temperature distribution;

FIG. 14 is a sectional view for exemplifying an installation example of the optical fiber useful in correcting the measured temperature distribution;

FIG. 15 is a diagram for exemplifying a measured temperature distribution outputted from the temperature measurement apparatus when a section within ±1 m around a heating center of the optical fiber is heated to 55° C. while the temperature of the other section is kept at room temperature (approximately 23° C.);

FIG. 16 is a schematic view for illustrating an example of installing the optical fiber by taking the influence from a heat source into consideration;

FIG. 17 is a flowchart for explaining a temperature measurement method according to an embodiment;

FIG. 18 is a diagram for exemplifying a temperature distribution (measured temperature distribution) outputted from the temperature measurement apparatus;

FIG. 19 is a diagram for illustrating a corrected temperature distribution when a correction is made once, together with a measured temperature distribution and an actual temperature distribution;

FIG. 20 is a diagram for illustrating a corrected temperature distribution acquired by replacement after the one-time correction, together with the measured temperature distribution and the actual temperature distribution;

FIG. 21 is a diagram for illustrating a corrected temperature distribution acquired when the correction calculation and the replacement are repeated 100 times, together with the measured temperature distribution and the actual temperature distribution;

FIG. 22 is a diagram for exemplifying a correction result of a comparative example;

FIG. 23 is a view for exemplifying a state where ten racks are disposed in a row and the optical fiber is installed in these racks (Part 1);

FIG. 24 is a diagram for illustrating examples of an actual temperature distribution, a measured temperature distribution, and a corrected temperature distribution when the optical fiber is installed as illustrated in FIG. 23;

FIG. 25 is a view for exemplifying a state where ten racks are disposed in a row and the optical fiber is installed in these racks (Part 2);

FIG. 26 is a diagram for illustrating examples of an actual temperature distribution, a measured temperature distribution, and a corrected temperature distribution when the optical fiber is installed as illustrated in FIG. 25;

FIG. 27 is an enlarged diagram of a portion of FIG. 26;

FIG. 28 is a view for exemplifying a state where ten racks are disposed in a row and the optical fiber is installed in these racks (Part 3);

FIG. 29 is a diagram for illustrating examples of an actual temperature distribution, a measured temperature distribution, and a corrected temperature distribution when the optical fiber is installed as illustrated in FIG. 28;

FIG. 30 is an enlarged diagram of a portion of FIG. 29; and

FIG. 31 is a view for illustrating a modified example of installation of the optical fiber.

### DESCRIPTION OF EMBODIMENTS

Description is given below with regard to embodiments with reference to the accompanying drawings.

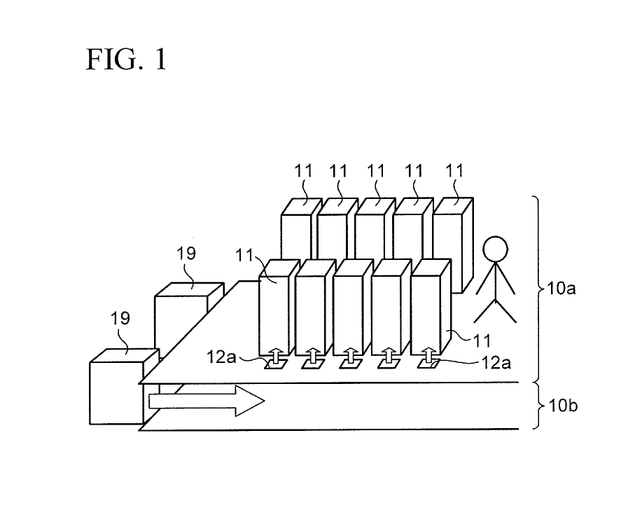

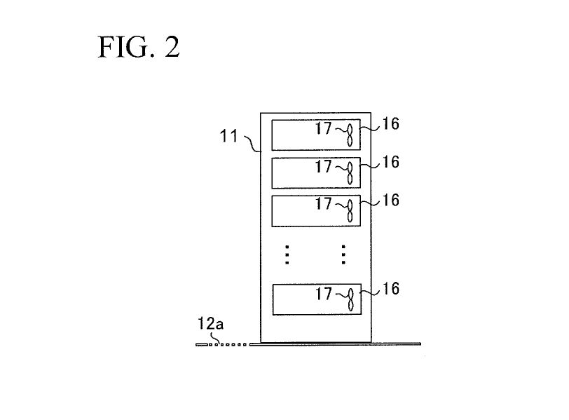

FIG. 1 is a schematic drawing for illustrating an example of a computer room. FIG. 2 is a schematic drawing for illustrating a state where computers are housed in a rack.

The computer room exemplified in FIG. 1 is partitioned into a device installation area 10a and a free access floor 10b provided under a floor of the device installation area 10a. Incidentally, the device installation area 10a is an example of a first area, and the free access floor 10b is an example of a second area.

In the device installation area 10a, multiple racks (server racks) 11 are aligned in each row. As illustrated in FIG. 2, multiple computers 16 (servers) are housed in each of the racks 11. Each of the computers 16 is provided with a cooling fan 17. As the cooling fan 17 rotates, air in the room flows into the rack 11 through one surface (hereinafter referred to as “inlet surface”) of the rack 11 and is discharged from the other surface (hereinafter referred to as “outlet surface”) of the rack 11.

The racks 11 adjacent to each other in different rows are disposed in such a manner that an inlet surface and an inlet surface, or an outlet surface and an outlet surface, face each other. The space between the rows serves as an aisle for the operator to pass through. In a floor of an aisle at the inlet surface side, grills (vent holes) 12a are disposed for each rack 11, so that the free access floor 10b communicates with the device installation area 10a.

Moreover, in the computer room, one or multiple air conditioners 19 are installed. The air conditioners 19 take in air from the device installation area 10a and adjust the temperature to supply low temperature air to the free access floor 10b. This low temperature air is sent to the device installation area 10a through the grills 12a and flows into the racks 11 through the inlet surfaces. Then, the air having a temperature increased by cooling the computers 16 in the racks 11 is discharged to the device installation area 10a from the outlet surfaces of the racks 11.

In the computer room depicted in FIG. 1, the rows of the racks adjacent to each other are disposed in such a manner that an inlet surface and an inlet surface, or an outlet surface and an outlet surface, of the racks 11 face each other. Thereby, an area where low temperature air is supplied through the grills 12a is spatially separated from an area where high temperature air is discharged from the racks 11. Hereinafter, an area at the rack-inlet surface side where low temperature air is supplied is called a cold aisle, and an area at the rack-outlet surface side where high temperature air is discharged is called a hot aisle. In the computer room, air circulates in the order of: the air conditioners 19, the free access floor 10b, the device installation area 10a (cold aisle), the racks 11, the device installation area 10a (hot aisle), and the air conditioners 19.

In the computer room as described above, it is desired to reduce the energy consumed by the air conditioning system. As one of the methods therefor, it is conceivable to control the airflow rate or the like of the air conditioners 19 in real time in accordance with a temperature distribution acquired by providing multiple measurement points at the inlet surface and the outlet surface of each rack 11 and constantly monitoring the temperature at each of the measurement points.

In this case, if a thermosensor such as a thermocouple or a thermistor is installed at each measurement point, this brings about a problem that the number of wires connecting these thermosensors to a measuring device becomes large, making the installation and maintenance of the wires complicated. For this reason, an optical fiber may be used as the thermosensors.

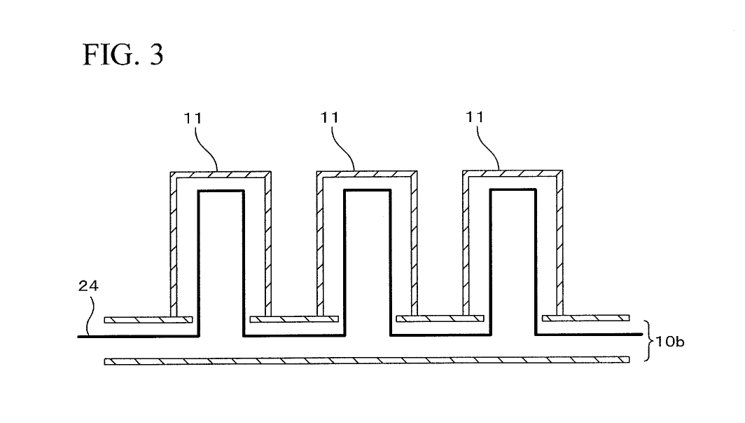

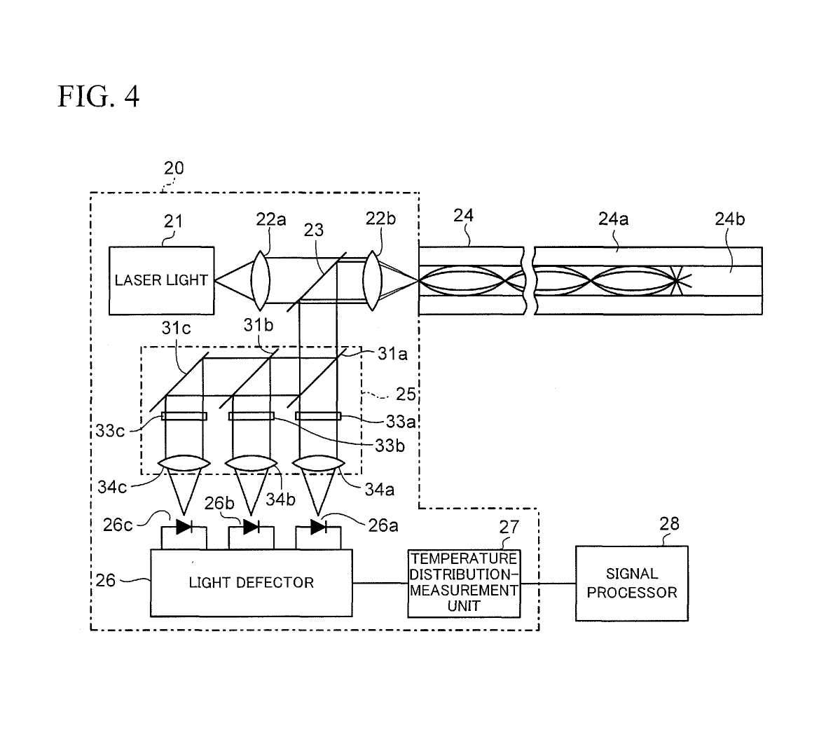

FIG. 3 is a schematic sectional view for describing a method of measuring a temperature distribution using an optical fiber as a thermosensor. FIG. 4 is an explanatory diagram for describing a temperature measurement system using the optical fiber.

As illustrated in FIG. 3, an optical fiber 24 is installed in such a manner as to sequentially pass through the racks 11 aligned in a row direction and pass through the free access floor 10b between one rack 11 and the next rack 11. An end portion of the optical fiber 24 is connected to a temperature measurement apparatus 20 as illustrated in FIG. 4.

The temperature measurement apparatus 20 has a laser light source 21, lenses 22a and 22b, a beam splitter 23, a wavelength separator 25, a light detector 26, and a temperature distribution-measurement unit 27.

The laser light source 21 outputs laser light with a predetermined pulse width in a constant cycle. The laser light passes through the lenses 22a, the beam splitter 23, and the lenses 22b, and then enters the optical fiber 24 through the end portion of the optical fiber 24 on the light source side. Note that, in FIG. 4, reference sign 24a denotes cladding of the optical fiber 24, and reference sign 24b denote a core of the optical fiber 24.

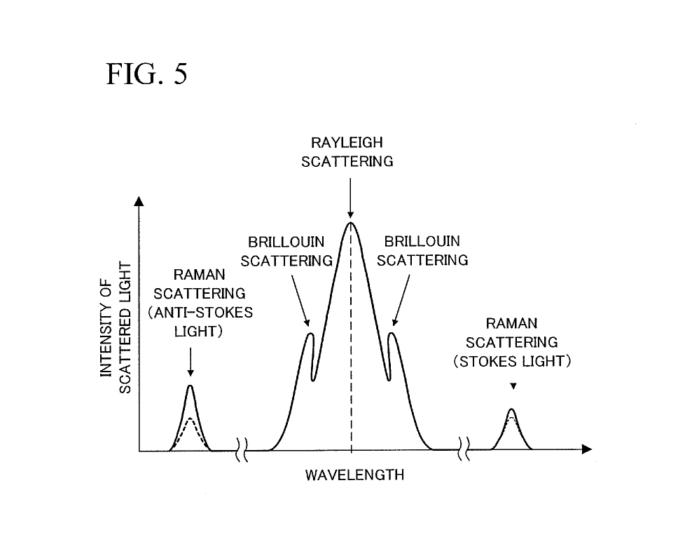

The light thus entered the optical fiber 24 is partially backscattered by molecules of the material of the optical fiber 24. The backscattered light includes Rayleigh scattered light, Brillouin scattered light, and Raman scattered light as exemplified in FIG. 5. Rayleigh scattered light is light having the same wavelength as that of the incident light. Brillouin scattered light and Raman scattered light are light having a wavelength shifted from that of the incident light.

Raman scattered light include Strokes light shifted to a long wavelength side from the incident light, and anti-Strokes light shifted to a short wavelength side from the incident light. The shift amount of each of Strokes light and anti-Strokes light depends on the wavelength of laser light and the material of the optical fiber 24, but is normally approximately 50 nm. In addition, the amount of Strokes light changed due to the temperature is small, while the amount of anti-Strokes light changed due to the temperature is large. In other words, it may be said that Strokes light has a small temperature dependency while anti-Strokes light has a large temperature dependency.

As illustrated in FIG. 4, the backscattered light returns through the optical fiber 24 and is emitted from the end portion on the light source side of the optical fiber 24. Then, the light passes through the lens 22b, is reflected by the beam splitter 23, and enters the wavelength separator 25.

The wavelength separator 25 has beam splitters 31a, 31b, 31c configured to transmit or reflect light depending on the wavelength thereof, and optical filters 33a, 33b, 33c configured to transmit light having a specific wavelength. Moreover, the wavelength separator 25 has condenser lenses 34a, 34b, 34c configured to condense light having passed through the optical filters 33a, 33b, 33c on light receivers 26a, 26b, 26c of the light detector 26.

The beam splitters 31a, 31b, 31c and the optical filters 33a, 33b, 33c separate the light incident on the wavelength separator 25 into Rayleigh scattered light, Strokes light, and anti-Strokes light, which are inputted into the light receivers 26a, 26b, 26c of the light detector 26. As a result, the light receivers 26a, 26b, 26c output signals corresponding to intensities of the Rayleigh scattered light, the Strokes light, and the anti-Strokes light.

The temperature distribution-measurement unit 27 acquires a measured temperature distribution along an installation path of the optical fiber 24 on the basis of the signals outputted from the light detector 26. A signal processor 28 corrects the measured temperature distribution outputted from the temperature measurement apparatus 20 and executes signal processing to make the measured temperature distribution close to an actual temperature distribution. The signal processing by the signal processor 28 will be described in detail later.

Meanwhile, the backscattered light generated in the optical fiber 24 attenuates while returning through the optical fiber 24. For this reason, in order to correctly evaluate the temperature at a position where backscattering occurs, it is preferable to take the attenuation of light into consideration.

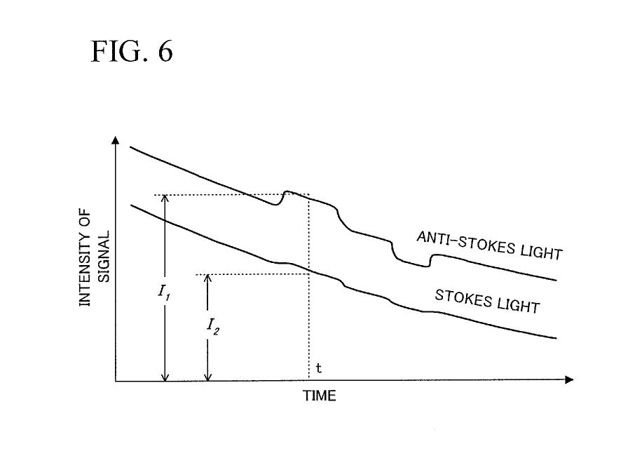

FIG. 6 is a diagram for illustrating an example of a time series distribution of the intensities of Raman scattered light. In FIG. 6, the horizontal axis represents time, while the vertical axis represents the intensities of signals outputted from the light receivers 26a, 26b, 26c of the light detector 26. The light detector 26 detects Strokes light and anti-Strokes light for a certain period immediately after a laser pulse enters the optical fiber 24. When the temperature is uniform over the entire length of the optical fiber 24, the signal intensity is decreased as time elapses with reference to the time when the laser pulse enters the optical fiber 24. In this case, the time represented by the horizontal axis indicates a distance from the end portion of the optical fiber 24 on the light source side to the position where the backscattering has occurred. The decrease in the signal intensity with time indicates the attenuation of light due to the optical fiber 24.

When the temperature is not uniform in the length direction of the optical fiber 24, for example, when a high temperature portion and a low temperature portion exist in the length direction, the signal intensities of Strokes light and anti-Strokes light do not attenuate uniformly, but peaks and troughs appear in curves representing the change in the signal intensity with time as illustrated in FIG. 6. In FIG. 6, I₁ represents the intensity of anti-Strokes light at certain time t, while I₂ represents that of Strokes light.

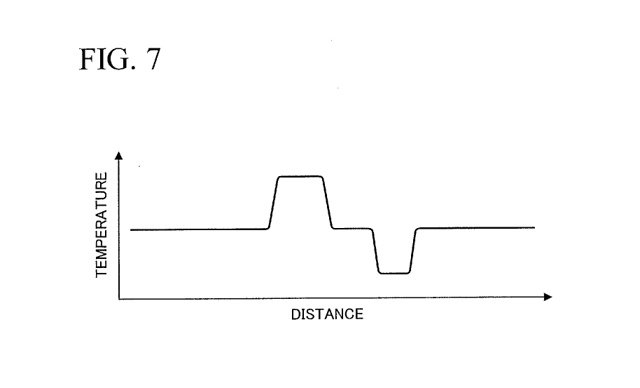

FIG. 7 is a diagram for illustrating the result of calculating an I₁/I₂ ratio for each time on the basis of the time series distribution of the intensities of the Raman scattered light in FIG. 6, while converting the horizontal axis (time) in FIG. 6 into distance and converting the vertical axis (signal intensity) into temperature. As illustrated in this FIG. 7, a temperature distribution in the length direction of the optical fiber 24 may be measured by calculating the intensity ratio (I₁/I₂) between anti-Strokes light and Strokes light.

Note that the intensities of Raman scattered light (Strokes light and anti-Strokes light) at the position where backscattering has occurred change due to temperature, but the temperature dependency of the intensity of Rayleigh scattered light is so small that it is negligible. Thus, it is preferable to correct the intensities of Strokes light and anti-Strokes light detected with the light detector 26 in accordance with a position where backscattering has occurred, the position being identified from the intensity of Rayleigh scattered light.

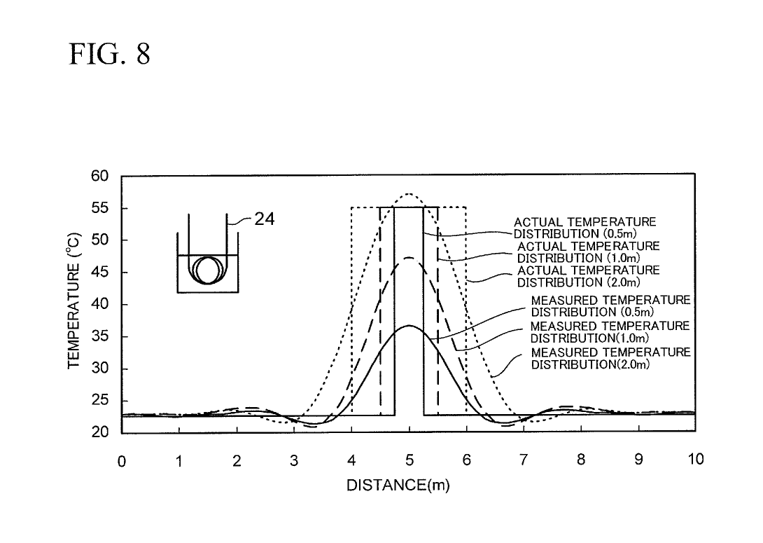

FIG. 8 is a diagram for exemplifying a relation between an actual temperature distribution and a temperature distribution (measured temperature distribution) outputted from the temperature measurement apparatus 20. In this example, a predetermined portion of the optical fiber 24 is immersed in hot water at a temperature of 55° C., giving a stepped actual temperature distribution, in which the temperature rises from room temperature to 55° C. Here, the length of the predetermined portion is selected from three lengths: 0.5 m, 1.0 m, and 2.0 m.

As illustrated in FIG. 8, each measured temperature distribution has a dull shape as a result of applying a weighted moving average to the actual temperature distribution. Accordingly, it may be understood that the above-described temperature measurement system (the optical fiber 24+the temperature measurement apparatus 20) has a low spatial frequency response, in other words, a poor position resolution.

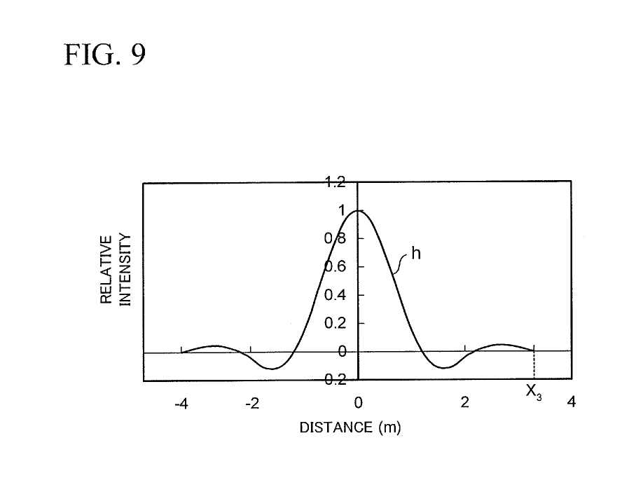

FIG. 9 is a diagram for illustrating a transfer function h of the temperature measurement system, which is obtainable from the stepped actual temperature distribution in FIG. 8. In this FIG. 9, the horizontal axis represents a distance from the heating center, while the vertical axis represents a relative intensity of temperature. A convolution of the transfer function h in FIG. 9 with the stepped temperature distribution in FIG. 8 provides the measured temperature distribution in FIG. 8. The transfer function h is substantially equal to the impulse response characteristic of the temperature measurement system.

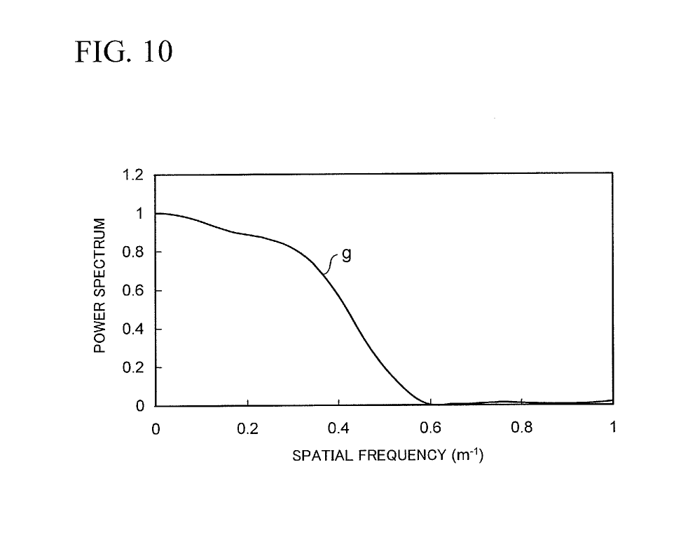

When the transfer function h is subjected to Fourier transformation, a function g having a shape as illustrated in FIG. 10 is obtained. As illustrated in FIG. 10, the power spectrum of the function g has a small value in a region where the spatial frequency is approximately 0.6 m⁻¹ or higher. Accordingly, it may be understood that the temperature measurement system using the optical fiber 24 as a thermosensor functions as a low-pass filter that blocks the region where the spatial frequency is approximately 0.6 m⁻¹ or higher, and thus a large portion of the frequency information in this region is lost.

For example, when the temperature in a tunnel or the temperature of a blast furnace is measured, the change in temperature along an installation path of an optical fiber is relatively little, so that measurement points do not have to be arranged densely. Thus, the temperature measurement system is not desired to have a high precision position resolution.

However, when the use is for temperature control in a computer room, the temperature is preferably measured at multiple measurement points in the racks 11. The measurement points are preferably arranged at relatively short intervals along the installation path of the optical fiber 24. In this case, the signal outputted from the temperature measurement apparatus 20 provides a temperature distribution having passed through the above-described low-pass filter. Hence, the temperature at each measurement point is not measured with high precision.

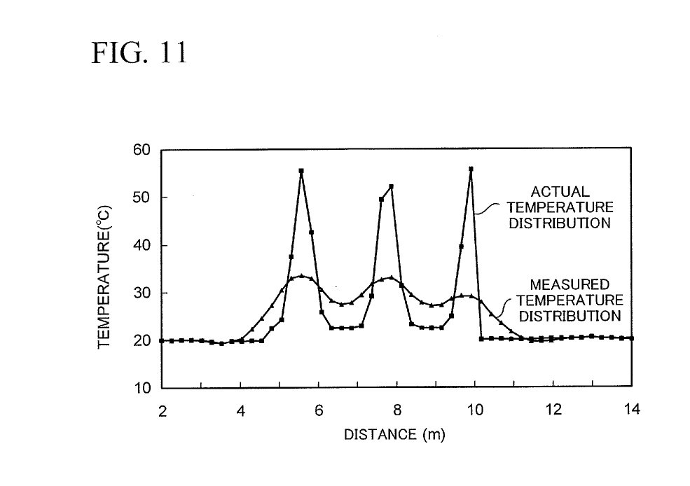

FIG. 11 is a diagram for illustrating a measured temperature distribution acquired by measuring an actual temperature distribution, in which the temperature changes at a relatively high spatial frequency, by use of the temperature measurement apparatus 20. Note that the actual temperature distribution in FIG. 11 is a measured value distribution of temperature by thermocouples.

As illustrated in FIG. 11, the measured temperature distribution has a shape as if obtained by applying a weighted moving average to the actual temperature distribution having passed through the low-pass filter.

Accordingly, it may be understood that, in order to acquire a temperature distribution in a temperature measurement area with high precision, a measured temperature distribution outputted from the temperature measurement apparatus 20 is preferably corrected with the signal processor 28 so as to make the measured temperature distribution close to the actual temperature distribution. As a method of correcting a measured temperature distribution in such a manner, it is conceivable to use an inverse filter (such as a deconvolution filter) adopting an inverse correction function obtained from an impulse response.

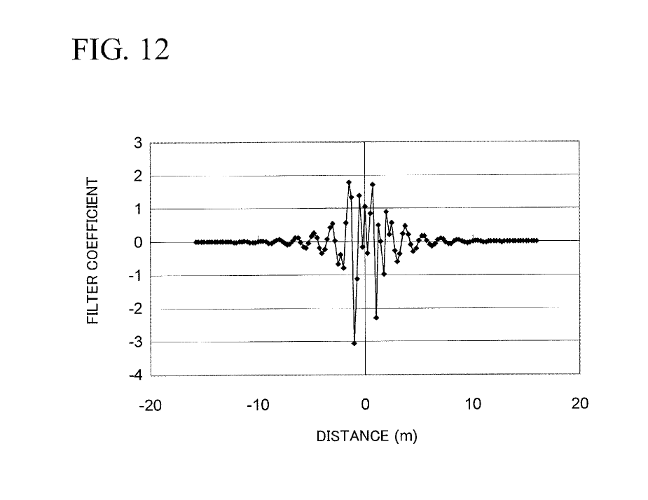

FIG. 12 is a diagram for exemplifying the characteristic of such an inverse filter. Note that the inverse filter illustrated in FIG. 12 has a margin tolerance increased by cutting the high frequency response of the inverse correction function obtained from the impulse response. In other words, this inverse filter is designed to reduce amplification of noise, if present, in a region of a measured temperature distribution where the spatial frequency is 0.6 m⁻¹ or higher.

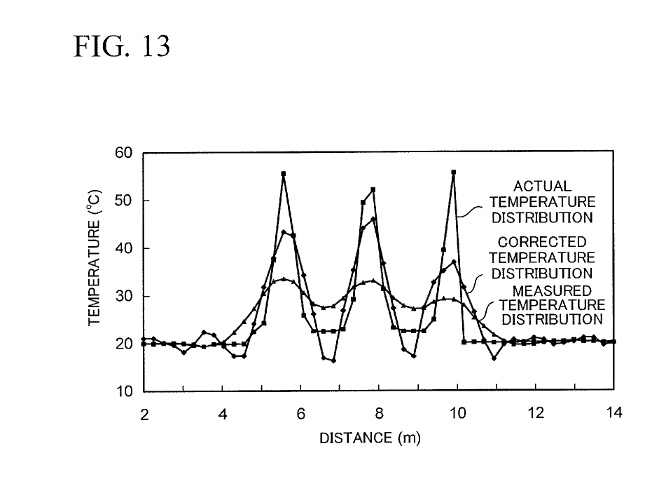

FIG. 13 is a diagram for exemplifying a corrected temperature distribution acquired by causing the inverse filter to act on the measured temperature distribution in FIG. 11, thereby correcting the measured temperature distribution.

As illustrated in FIG. 13, when a correction is made using the inverse filter, shaper peaks appear than in a case where no correction is made. However, it is difficult to say that the actual temperature distribution may be recovered precisely.

Moreover, a frequency component in the spatial frequency region lost by the action of the low-pass filter is not recovered well with the inverse filter if the power spectrum of the frequency component is smaller than the power spectrum of a frequency component in the spatial frequency region included in the noise during the measurement.

As described above, it is difficult to recover the spatial frequency component lost in measured temperature distribution by causing the inverse filter to act on a measured temperature distribution.

Thus, in the present embodiment, a measured temperature distribution is corrected as follows so as to make it close to an actual temperature distribution.

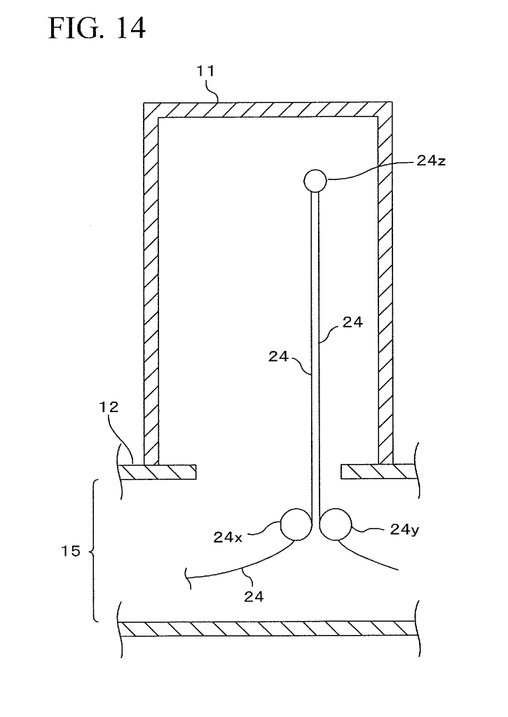

FIG. 14 is a sectional view for exemplifying an installation example of the optical fiber 24 useful in correcting a measured temperature distribution.

As illustrated in FIG. 14, in this installation example, a first coiled portion 24x and a second coiled portion 24y formed by winding portions of the optical fiber 24 are disposed in the free access floor 10b where the temperature is kept constant by air supplied from the air conditioner 19. Moreover, the optical fiber 24 between the first coiled portion 24x and the second coiled portion 24y is drawn and installed in the rack 11. Further, a third coiled portion 24z formed by winding a portion of the optical fiber 24 is disposed in an upper portion of the rack 11.

In addition, in the rack 11, the optical fiber 24 is installed in such a manner that at least a portion of the optical fiber-installation path from the first coiled portion 24x to the third coiled portion 24z overlaps at least a portion of the optical fiber-installation path from the third coiled portion 24z to the second coiled portion 24y. In the example of FIG. 14, the optical fiber 24 is installed in such a manner that the optical fiber-installation path from the first coiled portion 24x to the third coiled portion 24z completely overlaps the optical fiber-installation path from the third coiled portion 24z to the second coiled portion 24y.

The diameter of each of the coiled portions 24x, 24y, 24z is not particularly limited, but the lower limit is preferably twice the minimum bend radius allowable for the optical fiber 24 (approximately 15 mm). Meanwhile, the upper limit of the diameter of each of the coiled portions 24x, 24y, 24z is preferably to be a diameter (for example, 45 mm) that allows the coiled portion to be located within a region regarded to have the same temperature spatially.

As described above, by forming the coiled portions 24x, 24y, 24z with a small diameter, the temperatures at the measurement points in the coiled portions 24x, 24y, 24z may be regarded to be the same. For example, the temperature at any measurement point in the first coiled portion 24x and the second coiled portion 24y may be regarded as the same as the temperature of the free access floor 10b (the temperature of air blown from the air conditioner 19). Further, the temperature at any measurement point in the third coiled portion 24z may be regarded as the same.

In the present embodiment, the length of the optical fiber 24 wound in the first coiled portion 24x and the second coiled portion 24y is set as follows.

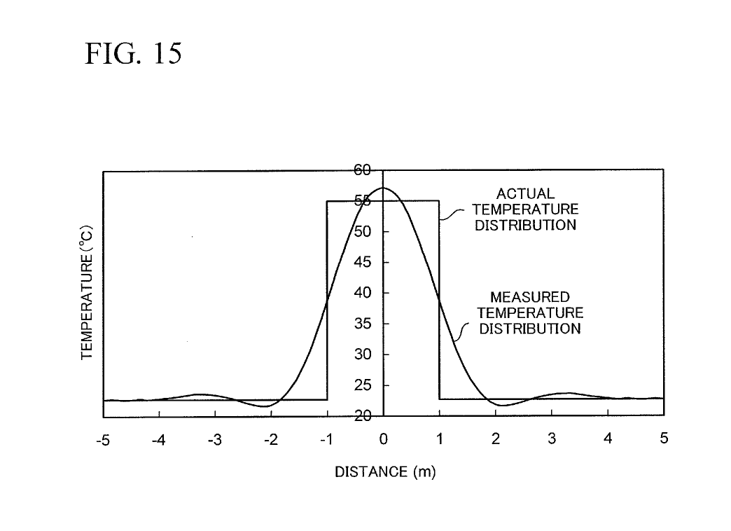

FIG. 15 is a diagram for exemplifying a measured temperature distribution outputted from the temperature measurement apparatus 20 when a section within ±1 m around a heating center of the optical fiber 24 is heated to 55° C. while the temperature of the other section is kept at room temperature (approximately 23° C.)

As seen from FIG. 15, the measured temperature distribution has portions spreading on outer sides of the section within ±1 m from the heating center, and the measured temperatures at the spreading portions do not become equal to room temperature which is the actual temperature. This is because if there is a temperature difference in the installation path of the optical fiber, the temperature difference makes the measured temperatures at neighboring measurement points affect each other.

The difference between the actual temperature and the measured temperature becomes smaller as the distance from the heating portion becomes longer. With the transfer function h in FIG. 9, for example, the transfer function h practically converges to 0 near a third zero point X₃ (=3.3 m) counted from the origin. Thus, it is understood that the measured temperature near the zero point X₃ is not affected by the heat source at the origin.

Hence, when the length of a section wound in each of the coiled portions 24x, 24y in the installation path of the optical fiber 24 in FIG. 14 is equal to or longer than the absolute value of the zero point X₃, even if a heat source exists in the installation path at an outer side of this section, a measurement point displaying an actual temperature without being affected by the heat source exists in this section.

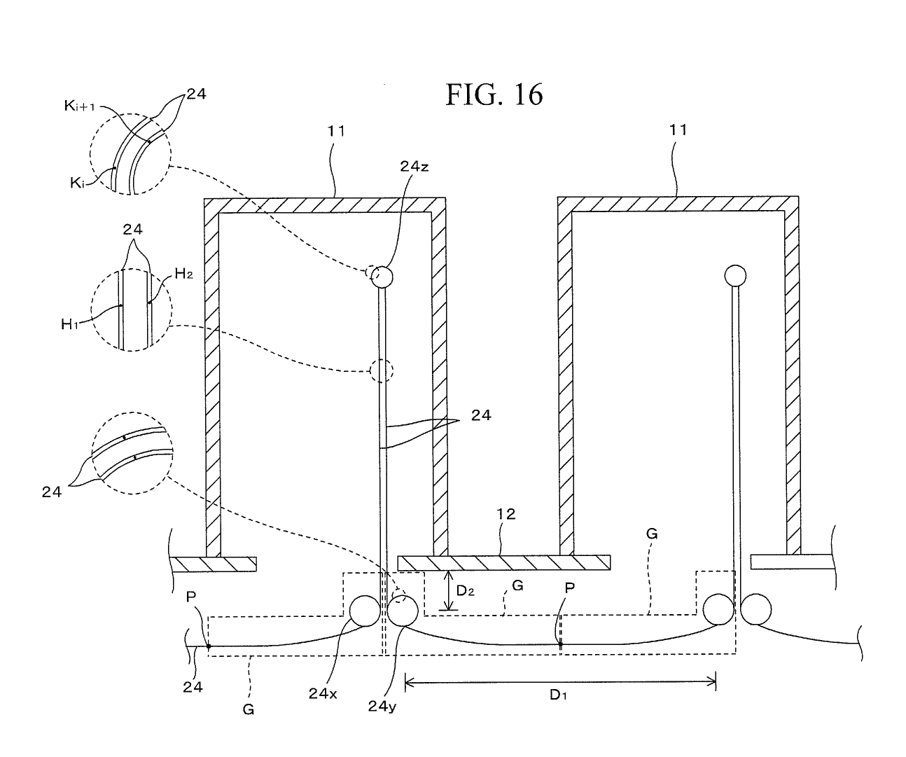

FIG. 16 is a schematic view for illustrating an example of installing the optical fiber 24 by taking the influence from such a heat source into consideration.

In the example of FIG. 16, D₁ denotes the length of the optical fiber 24 between the racks 11 adjacent to each other, and D₂ denotes the length of the optical fiber 24 from the coiled portions 24x, 24y to a lower surface of a floor 12 of the device installation area 10a.

In this case, the heat source is the computers in the racks 11. In addition, a section G of the installation path of the optical fiber 24 in the free access floor 10b may be regarded as having a temperature kept constant by air having a temperature adjusted by the air conditioner 19.

Note that, in this example, the section G is allocated to each of the coiled portions 24x and 24y, so that the starting point of the section G is the lower surface of the floor 12, and the end point thereof is a center point P of the adjacent racks 11.

A length L of the optical fiber 24 in the section G is (D₁/2)+D₂+D₃, where D₃ is the length of the portions of the optical fiber 24 wound in the coiled portions 24x, 24y. If this length L is equal to or longer than the absolute value of the zero point X₃ of the transfer function h, a measurement point not affected by heat from the computers in the racks 11 exists in the section G (the center point P in the example of FIG. 16). Moreover, it may be said that the temperatures at the other measurement points in the section G are the same as the temperature at this measurement point (center point P). In the present embodiment, the measured temperature at this measurement point (center point P) is set as a reference temperature, and a measured temperature distribution is corrected utilizing the sameness of the temperatures at the measurement points in the section G in the free access floor 10b.

The lengths D₁, D₂, D₃ are not particularly limited, as long as the length L of the optical fiber 24 in the section G is equal to or longer than the absolute value (3.3 m) of the zero point X₃ of the transfer function h. In this example, the length L is 3.3 m as D₁, D₂, and D₃ are set to 1.0 m, 0.5 m, and 2.3 m, respectively. Thus, the length L is set equal to or longer than the absolute value (3.3 m) of the zero point X₃ of the transfer function h.

The installation example of the optical fiber 24 in FIG. 16 has the following characteristics in addition to the above-described sameness of the measured temperatures in the section G

For example, in the rack 11, the optical fiber 24 is installed in such a manner that at least portions of an advancing path and a returning path of the optical fiber 24 overlap each other. Thus, overlapping points H₁ and H₂, which are measurement points regarded as having the same temperature, exist in the advancing path and the returning path. Accordingly, during the correction on the measured temperature distribution, a condition that the correction temperatures for the overlapping points H₁, H₂ are the same temperature may be added.

For the same reason, the measurement points in the third coiled portion 24z may be regarded as overlapping points Kᵢ having practically the same temperature. A condition that the temperatures at the overlapping points Kᵢ are the same may be added.

Hereinafter, a temperature measurement method utilizing the aforementioned characteristics will be described.

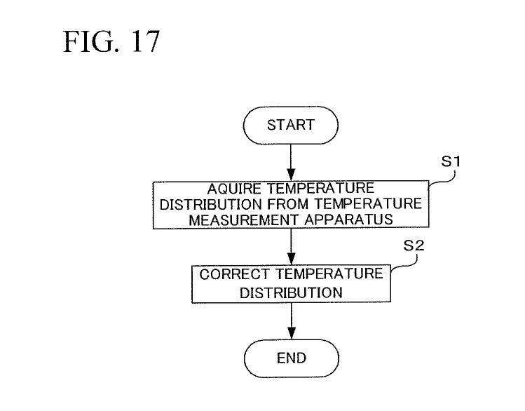

FIG. 17 is a flowchart for explaining the temperature measurement method according to the present embodiment. Each step in this flowchart is performed by the signal processor 28 configured to process the signal outputted from the temperature measurement apparatus 20.

In step S1 first, a measured temperature distribution along the installation path of the optical fiber 24 is acquired from the temperature measurement apparatus 20.

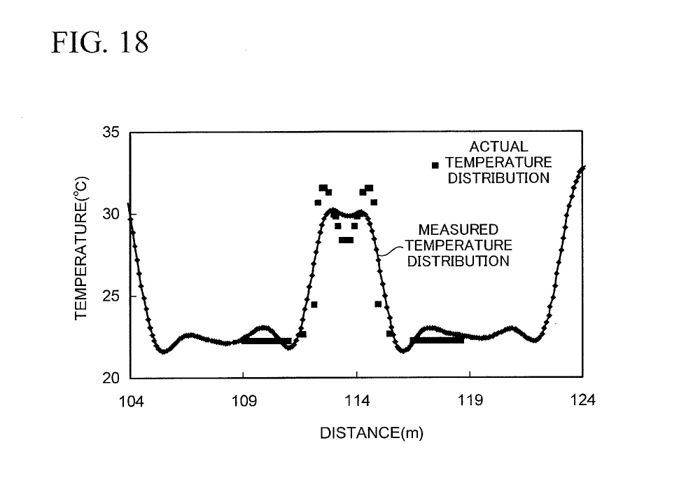

FIG. 18 is a diagram for exemplifying a temperature distribution (measured temperature distribution) outputted from the temperature measurement apparatus 20. In FIG. 18, the horizontal axis represents a distance from the end portion of the optical fiber 24, while the vertical axis represents a temperature. In this example, measurement points are provided at 0.1-m intervals in the length direction of the optical fiber 24. Additionally, thermocouples are provided at some measurement points to measure actual temperatures.

As seen from FIG. 18, the measured temperature distribution acquired by the temperature measurement apparatus 20 differs from the actual temperature distribution obtained by the thermocouples. Hence, in step S2, the measured temperature distribution is corrected as follows so as to make the measured temperature distribution close to the actual temperature distribution.

First, the measured temperature distribution is expressed as in Equation (1) below.

[Math. 1]

y={yₖ}ₖ₌₀^{k=∞} (1)

Here, the subscript k in the component yₖ indicates a k-th measurement point along the optical fiber-installation path. In addition, the component yₖ represents a value obtained by subtracting a reference temperature T_{AB} (in the example of FIG. 16, the measured temperature at the center point P) from the temperature measurement value at the k-th measurement point.

Moreover, the actual temperature distribution is expressed as in Equation (2) below.

[Math. 2]

x={xᵢ}ᵢ₌₀^{i=∞} (2)

As in the case of Equation (1), the subscript i in the component xᵢ indicates an i-th measurement point, and the component xᵢ represents a value obtained by subtracting the reference temperature T_{AB} from the actual temperature at the i-th measurement point i.

In this case, the measured temperature distribution y may be expressed as in Equation (3) below as a convolution of the actual temperature distribution x with the transfer function h.

$$\begin{matrix}[ Math . 4 ] & \\ \begin{matrix}{y}_{0} = {h}_{0} {x}_{0} \\ {y}_{1} = {h}_{0} {x}_{1} + {h}_{1} {x}_{0} \\ {y}_{2} = {h}_{0} {x}_{2} + {h}_{1} {x}_{1} + {h}_{2} {x}_{0}\end{matrix} \} & ( 4 )\end{matrix}$$

Here, i is within the range satisfying the condition that the subscript k−i is 0 or larger.

Further, the equation (3) may also be expressed for each component as in Equation (4) below.

$$\begin{matrix}[ Math . 3 ] & \\ {y}_{k} = {\sum }_{i = 0}^{∞} {h}_{k - i} {x}_{i} & ( 3 )\end{matrix}$$

According to Equation (4), each component hᵢ₋ⱼ of the transfer function may be calculated using a least squares method or the like while Equation (4) is viewed as simultaneous equations for hⱼ.

As the actual temperature distribution x and the measured temperature distribution y for obtaining each component hᵢ₋ⱼ of the transfer function, for example, the stepped actual temperature distribution as illustrated in FIG. 15 and a measured temperature distribution corresponding thereto may be used.

Note that since the optical fiber 24 has a group delay characteristic, the transfer function h changes in accordance with the distance from the light source. For this reason, the transfer function h is not defined unambiguously over the entire length of the optical fiber 24. However, for a short section of the optical fiber 24, the transfer function h may be defined unambiguously for the section with an assumption that the loss or delay of an optical signal in the optical fiber 24 is uniform.

Moreover, the transfer function h differs depending not only on the distance from the light source, but also on the material of the optical fiber 24, the pulse waveform of an incident laser ray, and the pulse response characteristic of the light detector 26. Accordingly, the transfer function h is preferably determined using the optical fiber 24 and the temperature measurement apparatus 20, which are actually employed.

Meanwhile, when Equation (3) is considered with a focus on a region where there is a change in temperature (hereinafter, focus region), regions therearound are regions where there is no change in temperature (regions having a temperature value of T_{AB}). In these regions, the values of the components xᵢ and yₖ are 0. Accordingly, xᵢ and yₖ of the regions around the focus region are meaningless in the calculation in Equation (3). For this reason, a column vector collecting components from Equation (2) but excluding all components which are around the focus region where there is a change in temperature, i.e., having the value of 0, is expressed as in Equation (5) below.

### [Math. 5]

x=(x₀,x₁,x₂, . . . , xₙ)^{t} (5)

In the case of the measured temperature distribution also, the values of components of a region where there is no change in temperature are 0 and meaningless in the calculation. Hence, a column vector collecting components from Equation (1) but excluding all components which are around the focus region where there is a change in temperature, i.e., having the value of 0, is expressed as in Equation (6) below.

[Math. 6]

y=(y₀,y₁,y₂, . . . , yₘ)^{t} (6)

The numbers of the components of the column vectors in Equations (5) and (6) are n+1 and m+1, respectively. However, of m and n, m is the larger than n(m>n). This is because the measured temperature distribution spreads wider than the actual temperature distribution in a horizontal direction as illustrated in FIG. 15, and hence the measured temperature distribution has a larger number of components not being 0.

As in Equations (5) and (6), in a case where the actual temperature distribution x and the measured temperature distribution y are set as column vectors with a finite dimension while Equation (4) is expressed in the form of Equation (7) below, [H] is formed on the basis of the transfer function h and has a finite number, (m+1)×(n+1), of components. [H], which is formed in this manner, is called a matrix representation of the transfer function.

[Math. 7]

y=[H]x (7)

Note that the dimension of each of the column vectors x and y in Equation (7) is a finite dimension as in Equations (5) and (6).

In Equation (7), components yᵢ of the column vector y correspond to a number, m+1, of values obtained by temperature measurement, and [H] may be regarded as a coefficient matrix of (m+1)×(n+1) of simultaneous equations. As described above, since the relationship m>n holds true, the simultaneous equations are underspecified for x. For this reason, in the present embodiment, a square error e as in Equation (8) below is considered.

[Math. 8]

e=∥y−[H]X∥²=(y−[H]X)^{t}(y−[H]X) (8)

Note that, similarly to the actual temperature distribution, the column vector X in Equation (8) is an n-dimensional vector having components as illustrated in Equation (9) below.

[Math. 9]

X=(X₀,X₁,X₂, . . . , Xₙ)^{t} (9)

The column vector X that makes the e value in Equation (8) small approximately satisfies Equation (7) as well. The smaller the e value in Equation (8), the higher the precision of approximation, and the column vector X becomes closer to the column vector x (actual temperature distribution). Hereinafter, the column vector X is also called a corrected temperature distribution of the column vector y (measured temperature distribution). According to this, Equation (8) may be said to be an equation for calculating the square error e between the measured temperature distribution y and a convolution of the transfer function h of the optical fiber 24 along the installation path with the corrected temperature distribution X.

In order to acquire the corrected temperature distribution X that makes the square error e as small as possible, a gradient vector ∂e/∂X of the square error e is calculated from Equation (8) according to Equation (10) below.

$$\begin{matrix}[ Math . 10 ] & \\ \begin{matrix}\frac{\partial e}{\partial X} = [ \begin{matrix}\frac{\partial e}{\partial {X}_{1}} \\ \frac{\partial e}{\partial {X}_{2}} \\ ⋮ \\ \frac{\partial e}{\partial {X}_{n}}\end{matrix} ] \\ = \frac{\partial }{\partial X} {‖ y - [ H ] X ‖}^{2} \\ = - {2 [ H ]}^{t} ( y - [ H ] X ) \\ = - 2 ( {[ H ]}^{t} y - {[ H ]}^{t} [ H ] X )\end{matrix} & ( 10 )\end{matrix}$$

In order that the gradient vector ∂e/∂X becomes 0, components Xᵢ of the column vector X are determined by a least squares method.

Note that if the diagonal component of [H]^{t}[H] in Equation (10) is slightly increased in consideration of noise during the measurement, amplification of the high frequency component of the noise may be suppressed, and the margin tolerance may be increased. The above-described correction with the inverse filter (see FIG. 13) corresponds to the correction calculated by this least squares method.

Here, the gradient vector ∂e/∂X indicates a direction, in which the square error e increases. Accordingly, a movement in a direction of a reverse sign −∂e/∂X decreases the square error e.

Hence, in the present embodiment, the correction is sequentially made on the column vector X as in Equation (11) below.

$$\begin{matrix}[ Math . 11 ] & \\ {X}^{( k + 1 )} = {X}^{( k )} - α \frac{\partial e}{\partial X} {\vert}_{X = {X}^{( k )}} & ( 11 )\end{matrix}$$

Here, k represents the number of repetitions of the correction, and X^{(k)} represents a corrected temperature distribution after the correction is made k times. The components of this X^{(k)} may be expressed as in Equation (12) below.

[Math. 12]

X^{(k)}=(X₀^{(k)},X₁^{(k)}, . . . , Xₙ^{(k)})^{t} (12)

In addition, α represents a positive correction coefficient to which Equation (11) converges, and may be selected within a range of 0.5 to 1 empirically. Hereinafter, calculation is performed where α is 0.5.

Moreover, an initial value X⁽⁰⁾ is a zero vector. For calculation of ∂e/∂X in Equation (11), Equation (10) is used in which the diagonal component of [H]^{t}[H] is slightly increased.

In the present embodiment, calculation is repeated using Equation (11). Thereby, calculation for a corrected temperature distribution X^{(k+1)} which makes the square error e further smaller than X^{(k)} is performed sequentially multiple times.

Meanwhile, as described with reference to FIG. 16, in the installation path of the optical fiber 24, the temperature at each measurement point in the section G is the same as the temperature at the center point P (the reference temperature). Hence, in the present embodiment, components Xᵢ^{(k)} corresponding to multiple measurement points included in the first and the second coiled portions 24x and 24y in the section G are replaced with the measured temperature at the center point P every time the correction calculation according to Equation (11) is performed. Since each component of the column vectors x, y, X is a value obtained by subtracting the reference temperature T_{AB} from the real value as described above, the replaced value of each component Xᵢ^{(k)} is 0 (=T_{AB}−T_{AB}).

Note that the reference temperature T_{AB} is not limited to the temperature at the center point P. For example, the reference temperature T_{AB} may be an average value of measured values at multiple measurement points selected from the measurement points in the section G. In this case, by increasing the length D₃ of the portions of the optical fiber 24 wound in the coiled portions 24x, 24y to a length longer than the aforementioned length of 2.3 m, the number of measurement points not affected by the heat sources in the racks 11 is increased, and the reliability of the reference temperature is improved.

Moreover, as described with reference to FIG. 16, the overlapping points H₁ and H₂, which are regarded as having the same temperature, exist in the paths between the coiled portions 24x, 24y and the third coiled portion 24z in the optical fiber 24. Accordingly, for these overlapping points also, components Xᵢ₁^{(k)} and Xᵢ₂^{(k)} of the corrected temperature distribution at the respective overlapping points H₁ and H₂ are replaced with an average value X_{avg1}(=(Xᵢ₁^{(k)}+Xᵢ₂^{(k)})/2) of corrected temperatures at these overlapping points H₁ and H₂ every time the correction calculation according to Equation (11) is performed. The corrected temperatures Xᵢ₁^{(k)} and Xᵢ₂^{(k)} are component values at measurement points i₁ and i₂ corresponding to the overlapping points H₁ and H₂ among the multiple component Xᵢ^{(k)} of the corrected temperature distribution X^{(k)}. The average value X_{avg1} of these has the meaning as the common estimated temperature for the overlapping points H₁ and H₂.

Furthermore, similarly to this, for the multiple overlapping points Kᵢ in the third coiled portion 24z also, components Xᵢ^{(k)} of the measured temperature distribution at overlapping points K₁ are replaced with an average value X_{avg2} of corrected temperatures Xᵢ^{(k)} at these overlapping points Kᵢ every time the correction calculation according to Equation (11) is performed. As described above, the corrected temperatures Xᵢ^{(k)} are component values at measurement points corresponding to the overlapping points Kᵢ among the multiple components Xᵢ^{(k)} of the corrected temperature distribution X^{(k)}. Moreover, the average value X_{avg2} of these has the meaning as the common estimated temperature for the overlapping points Kᵢ.

For example, in the present embodiment, the interval between the measurement points in the optical fiber 24 is set to 0.1 m. Accordingly, when the length of the portion of the optical fiber 24 wound in the third coiled portion 24z is 0.5 m, the number of the overlapping points Kᵢ is 5 (=0.5 m/0.1 m). Thus, components Xᵢ₋₂^{(k)}, Xᵢ₋₁^{(k)}, Xᵢ^{(k)}, Xᵢ₊₁^{(k)}, Xᵢ₊₂^{(k)} of the corrected temperature distribution at these overlapping points Kᵢ₋₂, Kᵢ₋₁, Kᵢ, Kᵢ₊₁, Kᵢ₊₂ may be replaced with an average value X_{avg2}(=(Xᵢ₋₂^{(k)}+Xᵢ₋₁^{(k)}+Xᵢ^{(k)}+Xᵢ₊₁^{(k)}+Xᵢ₊₂^{(k)})/5) of corrected temperatures Xᵢ₋₂^{(k)}, Xᵢ₋₁^{(k)}, Xᵢ^{(k)}, Xᵢ₊₁^{(k)}, Xᵢ₊₂^{(k)} at the respective points every time the correction calculation is performed.

Meanwhile, in the present embodiment, the temperature at any measurement point in the coiled portions 24x, 24y is regarded as T_{AB} as described above. Moreover, each component of the column vectors x, y, X is a value obtained by subtracting T_{AB} from the real temperature. Thus, in order to acquire a final corrected temperature distribution Tᵢₒₘₚ_{_{—}}ᵢ, the temperature T_{AB} is added as in Equation (13) below after the calculation according to Equation (11) is ended a required number of times for repetition (n times).

[Math. 13]

Tᵢₒₘₚ_{_{—}}ᵢ=Xᵢ⁽ⁿ⁾+T_{AB} (13)

In addition, in the optical fiber 24, the temperature of a portion disposed in the device installation area 10a (including the inside of the racks 11) does not fall below the temperature of the coiled portions 24x, 24y disposed in the free access floor 10b. This condition is expressed as in Equation (14) below.

[Math. 14]

Xᵢ^{(k)}≧0 (14)

Thus, if there is a component that makes Xᵢ^{(k)}<0 at k-th calculation according to Equation (11), the component Xᵢ^{(k)} is set to 0, and then (k+1)th calculation is performed.

In this manner, in a case where the temperature measurement area includes a portion known to have a temperature equal to or higher than a predetermined temperature, when the corrected temperature at the portion using Equation (11) becomes lower than the predetermined temperature, the calculation is simplified by replacing the corrected temperature at the portion with the predetermined temperature.

In contrast, in a case where the temperature measurement area includes a portion known to have a temperature equal to or lower than a predetermined temperature, the corrected temperature at the portion using Equation (11) is replaced with the predetermined temperature, when the corrected temperature at the portion becomes higher than the predetermined temperature, as well.

In step S2, the correction calculation using Equation (11) is repeated as described above, and the final corrected temperature distribution Tᵢₒₘₚ_{_{—}}ᵢ is acquired from an index for the amount of decrease in the square error e, for example, Xᵢ⁽ⁿ⁾ with which e⁽ⁿ⁾−e⁽ⁿ⁻¹⁾ becomes a predetermined value or smaller. Note that e⁽ⁿ⁾ is a square error obtained from Equation (8) using X⁽ⁿ⁾ obtained by making the correction according to Equation (11) n times.

As described above, the primary steps of the temperature measurement method according to the present embodiment are completed.

Next, effects of the aforementioned temperature measurement method will be described.

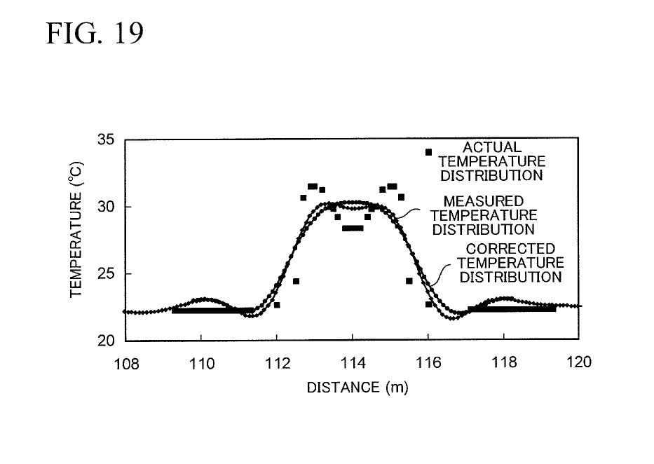

FIGS. 19 to 21 are diagrams for exemplifying corrected measured temperature distributions, in each of which the horizontal axis represents a distance from the end portion of the optical fiber 24, while the vertical axis represents a temperature.

FIG. 19 is a diagram for illustrating a corrected temperature distribution when the correction according to Equation (11) is made once, together with a measured temperature distribution and an actual temperature distribution. As illustrated in this FIG. 19, the one-time correction does not eliminate the difference between the actual temperature distribution and the corrected temperature distribution.

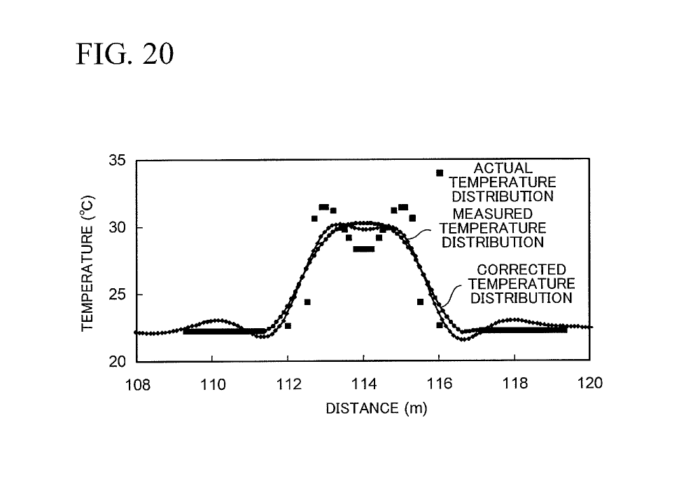

FIG. 20 is a diagram for illustrating a corrected temperature distribution acquired by the above-described replacement in each region and the section G and at the points H₁, H₂, Kᵢ after the one-time correction, together with the measured temperature distribution and the actual temperature distribution.

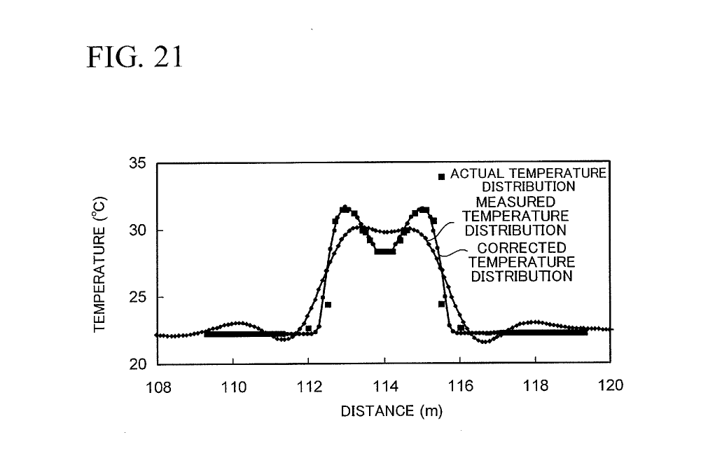

FIG. 21 is a diagram for illustrating a corrected temperature distribution when such correction calculation and replacement are repeated 100 times, together with the measured temperature distribution and the actual temperature distribution. As illustrated in this FIG. 21, when the correction calculation and the replacement are performed 100 times, the corrected temperature distribution substantially coincides with the actual temperature distribution.

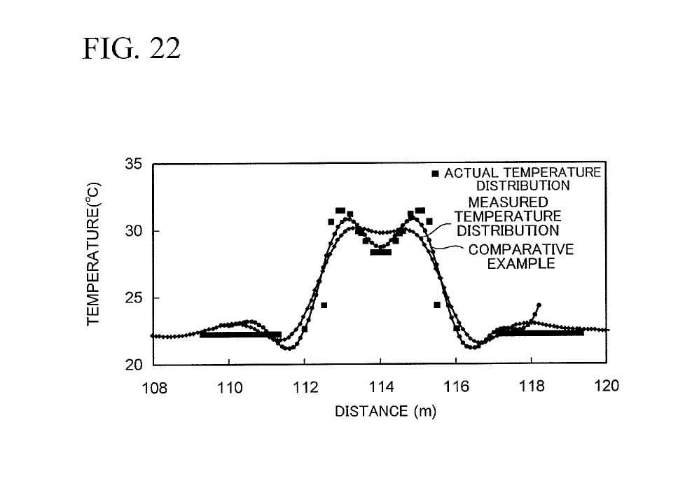

FIG. 22 is a diagram for exemplifying a correction result of a comparative example. In this comparative example, no temperature replacement is performed on measurement points in a free access floor and measurement points at overlapping points unlike the present embodiment, but the correction according to Equation (11) is made 100 times. As illustrated in FIG. 22, it may be seen from the illustrated result that the comparative example does not eliminate the difference from the actual temperature distribution.

As described above, in the present embodiment, every time the correction calculation according to Equation (11) is performed, corrected temperatures at specific measurement points in the installation path of the optical fiber 24 are replaced with a known temperature or an average temperature. This may make it possible to acquire a corrected temperature distribution close to an actual temperature distribution. Thereby, even if the actual temperature changes in a short cycle along the installation path of the optical fiber 24 as in the rack 11, temperature measurement may be performed with high precision.

Moreover, by utilizing the temperature measurement result, the cooled state of the device installation area 10a and the like may be kept optimum while the airflow rate of the air conditioners 19 (see FIG. 1) is controlled in real time to suppress the air conditioning energy.

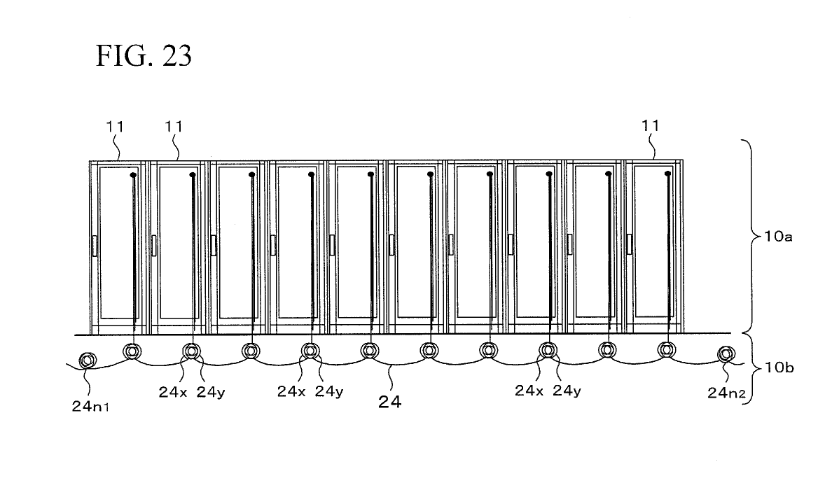

FIG. 23 is a view for exemplifying a state where ten racks 11 are disposed in a row and the optical fiber 24 is installed in these racks 11 (Part 1). Here, the first coiled portion 24x and the second coiled portion 24y are provided for each rack 11. The first coiled portion 24x and the second coiled portion 24y are disposed at the same site in the free access floor 10b. Moreover, coiled portions 24ₙ₁, 24ₙ₂ are disposed at both ends of the rack row. Further, the optical fiber 24 between the first coiled portion 24x and the second coiled portion 24y is drawn and disposed at the outlet surface of each rack 11.

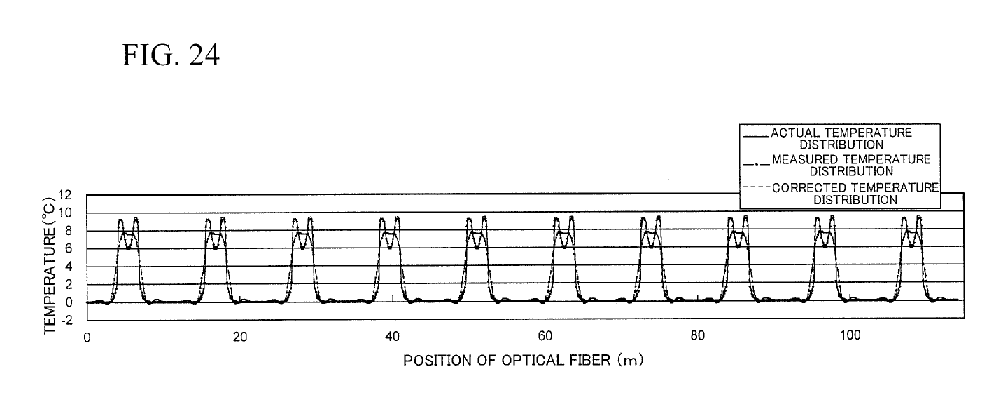

FIG. 24 is a diagram for illustrating examples of an actual temperature distribution, a measured temperature distribution, and a corrected temperature distribution when the optical fiber 24 is installed as illustrated in FIG. 23. In FIG. 24, the horizontal axis represents a position of the optical fiber 24 in the length direction, while the vertical axis represents a temperature (here, a difference from the reference temperature). Note that the corrected temperature distribution is obtained by repeating the correction using Equation (11) 100 times as described above, and replacing the temperature at each measurement point in the free access floor 10b with the reference temperature every time the correction is made.

From this FIG. 24, it may be seen that a temperature distribution (corrected temperature distribution) close to an actual temperature distribution may be acquired by installing the optical fiber 24 as illustrated in FIG. 23 and causing the signal processor 28 to repeat the aforementioned correction and replacement on a measured temperature distribution outputted from the temperature measurement apparatus 20.

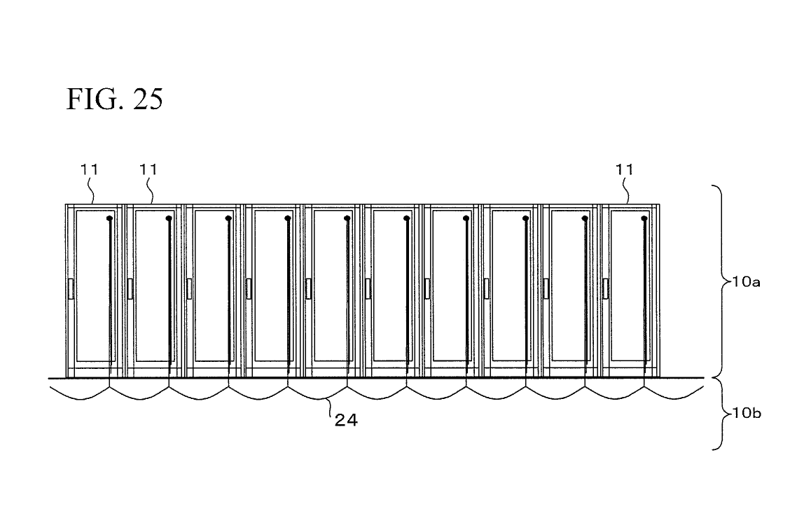

FIG. 25 is a view for exemplifying a state where ten racks 11 are disposed in a row and the optical fiber 24 is installed in these racks 11 (Part 2). Note that, in the example of FIG. 25, no coiled portion is provided in the free access floor 10b unlike the example of FIG. 23.

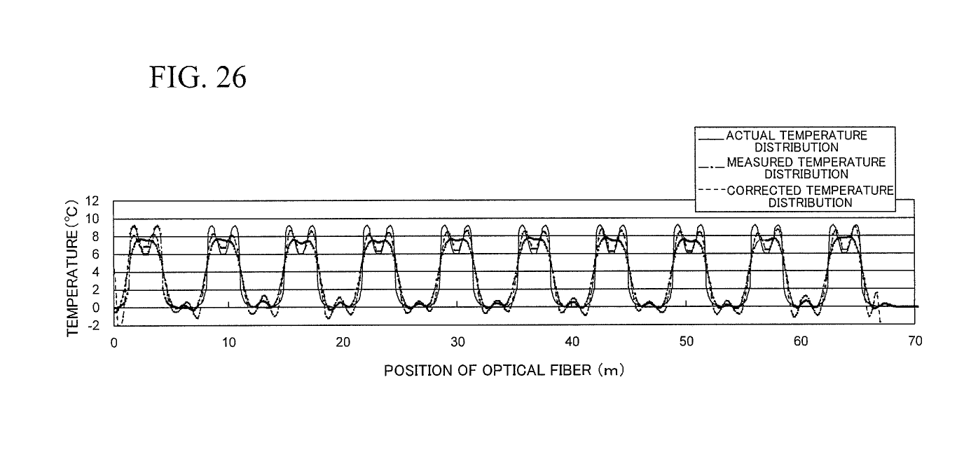

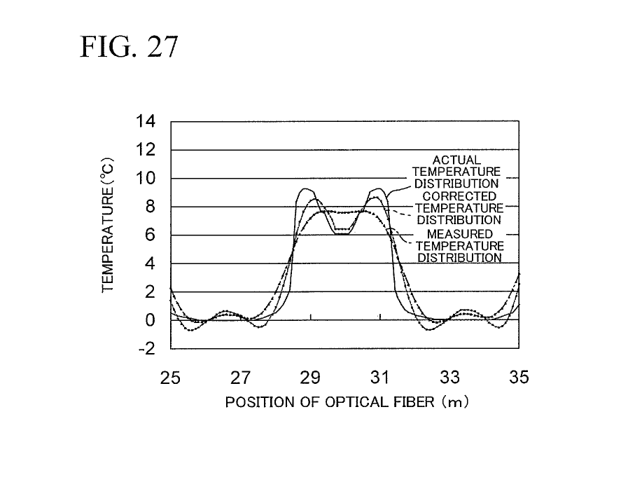

FIG. 26 is a diagram for illustrating examples of an actual temperature distribution, a measured temperature distribution, and a corrected temperature distribution when the optical fiber 24 is installed as illustrated in FIG. 25. In FIG. 26, the horizontal axis represents a position of the optical fiber 24 in the length direction, while the vertical axis represents a temperature (here, a difference from the reference temperature). Note that, here, the correction using Equation (11) is repeated 100 times, but no temperature replacement is performed after the correction on measurement points. Further, FIG. 27 is an enlarged diagram of a portion of FIG. 26.

As seen from FIGS. 26 and 27, in a case where no replacement is performed, even if the correction is made 100 times, the difference between a corrected temperature distribution and an actual temperature distribution is relatively large.

Meanwhile, in a case where the optical fiber 24 is installed as illustrated in FIG. 23, a corrected temperature distribution substantially equal to an actual temperature distribution may be acquired. Nevertheless, since the length of the optical fiber 24 per rack is long, the number of racks 11 measurable by one optical fiber 24 is small.

For example, suppose that the length of the optical fiber 24 installed in each rack 11 is 4.0 m; the length of the optical fiber 24 wound in the coiled portions 24x, 24y is 2.3 m; the distance from the coiled portions 24x, 24y to the rack 11 (D₂ in FIG. 16) is 0.5 m; the distance between the racks 11 adjacent to each other (D₁ in FIG. 16) is 1 m; and the length of the optical fiber 24 wound in the coiled portions 24ₙ₁, 24ₙ₂ is 3.3 m. The length of the optical fiber 24 per rack is approximately 11.3 m (≈4 m+2.3 m×2+0.5 m×2+1 m+3.3 m×2/10).

In this case, when the length of one optical fiber 24 is 1 km (=1000 m), the number of racks in which one optical fiber 24 may be installed is 88 (≈1000 m/11.3 m).

Meanwhile, in a case where the optical fiber 24 is installed as illustrated in FIG. 25, the number of the racks 11 in which one optical fiber 24 may be installed is large, but the temperature measurement precision is not satisfactory as described above.

Hereinafter, a method to eliminate these problems will be described.

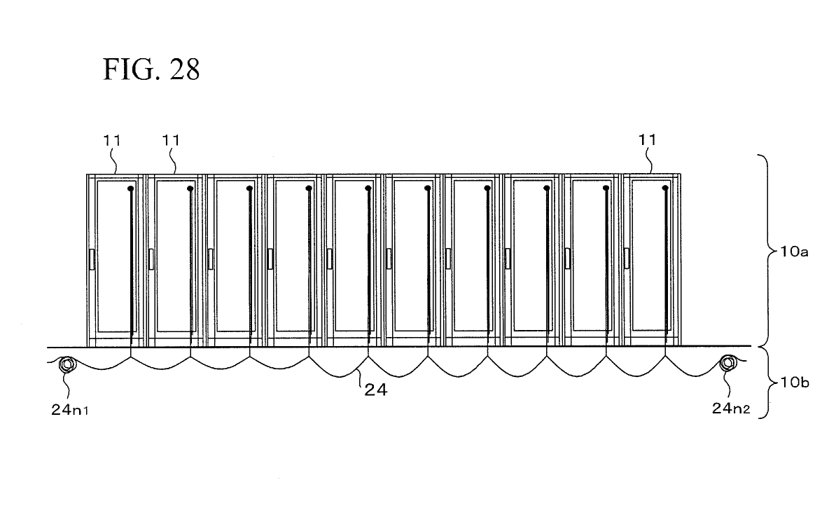

FIG. 28 is a view for exemplifying a state where ten racks 11 are disposed in a row and the optical fiber 24 is installed in these racks 11 (Part 3). Here, the coiled portions 24ₙ₁, 24ₙ₂ are disposed at both ends of the rack row, but no coiled portion is provided between the racks 11. Note that the optical fiber 24 of 6.6 m (twice the third zero point X₃) is wound in each of the coiled portions 24ₙ₁, 24ₙ₂. Accordingly, it may be said that the measured temperatures at center points of the optical fiber 24 wound in the coiled portions 24ₙ₁, 24ₙ₂ are not affected by heat sources in the racks 11 and in the temperature measurement apparatus 20, and reflect the temperature (actual temperature) of the free access floor 10b. Thus, in this example, the measured temperatures at center points of the coiled portions 24ₙ₁, 24ₙ₂ are used as a reference temperature.

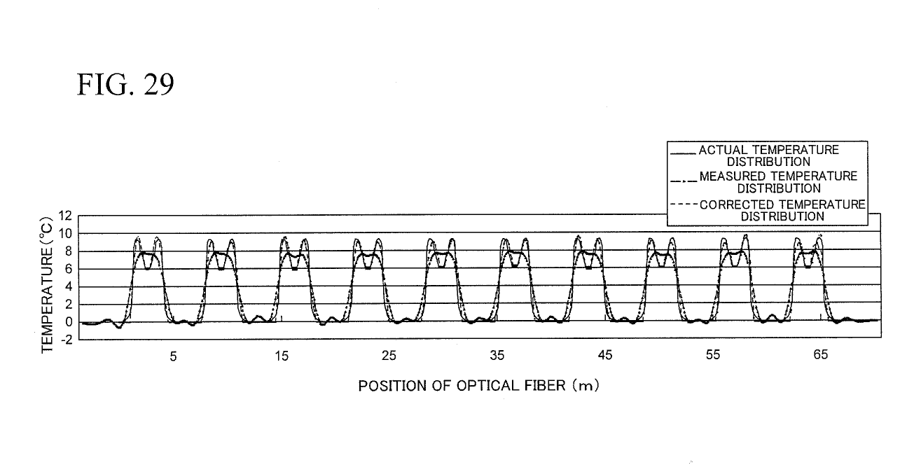

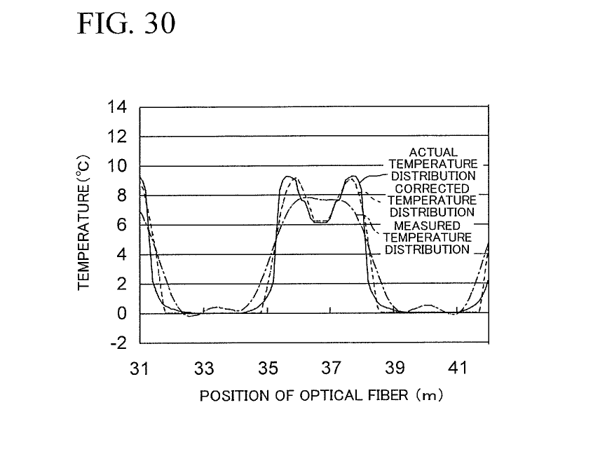

FIG. 29 is a diagram for illustrating examples of an actual temperature distribution, a measured temperature distribution, and a corrected temperature distribution when the optical fiber 24 is installed as illustrated in FIG. 28. In FIG. 29, the horizontal axis represents a position of the optical fiber 24 in the length direction, while the vertical axis represents a temperature (a difference from the reference temperature). Further, FIG. 30 is an enlarged diagram of a portion of FIG. 29.

In this example, all the measurement points included in the optical fiber 24 between the coiled portion 24ₙ₁ and the coiled portion 24ₙ₂ are considered as a single matrix. In addition, the correction using Equation (11) is repeated 100 times as described above, and the temperatures at the measurement points in the free access floor 10b are replaced with the reference temperature every time the correction is made.

From FIGS. 29 and 30, it may be seen that a temperature distribution (corrected temperature distribution) close to an actual temperature distribution may be acquired as in the example of FIGS. 23 and 24 by installing the optical fiber 24 as illustrated in FIG. 28 and causing the signal processor 28 to repeat the aforementioned correction and replacement on a measured temperature distribution outputted from the temperature measurement apparatus 20.

In this case, suppose that the length of the optical fiber 24 installed in each rack 11 is 4.0 m; the distance from the free access floor 10b to the rack 11 (corresponding to D₂ in FIG. 16) is 0.5 m; the distance between the racks 11 adjacent to each other (D₁ in FIG. 16) is 1 m; and the length of the optical fiber 24 wound in the coiled portions 24ₙ₁, 24ₙ₂ is 6.6 m. The length of the optical fiber 24 per rack is approximately 7.3 m (≈4 m+0.5 m×2+1 m+6.6 m×2/10). Thus, when the length of one optical fiber 24 is 1 km (=1000 m), the number of the racks 11 in which one optical fiber 24 may be installed is 136 in the example of FIG. 28. This is approximately 55% increase in comparison with the example of FIGS. 23 and 24. This may enable precise and efficient measurement of a temperature distribution in a facility such as a data center.

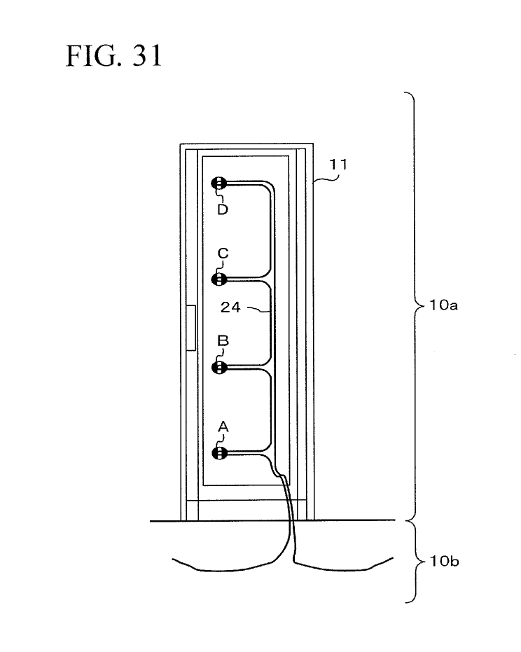

Note that, in the above-described embodiment, the optical fiber 24 is vertically installed at the outlet surface of the rack 11, but may be installed as illustrated in FIG. 31. In the example of this FIG. 31, the optical fiber 24 is installed in such a manner as to be drawn from the free access floor 10b into the rack 11 so as to go from the bottom to the top along the outlet surface and then return to the bottom. Moreover, in the advancing path, coiled portions A, B, C, D of the optical fiber 24 are disposed at positions corresponding to exhaust ports of four servers (unillustrated) housed in the rack 11. Further, the optical fiber 24 in the returning path is installed in such a manner as to pass through the same positions as the optical fiber in the advancing path except for the portions of the coiled portions A, B, C, D and the vicinities of the coiled portions.

In a case where the optical fiber 24 is installed as illustrated in this FIG. 31 also, a temperature distribution (corrected temperature distribution) close to an actual temperature distribution may be acquired by repeating the correction using Equation (11) and replacing temperatures at measurement points in the free access floor 10b and measurement points at overlapping points with a known temperature or an average temperature every time the correction is made as in the aforementioned examples.

Note that, in the above-described embodiments, the description has been given with regard to the temperature measurement in the computer room. However, this disclosed technology may be applicable also to temperature measurement in facilities such as office buildings and factories.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A temperature measurement system comprising:
a first area having a plurality of temperature-measurement targets;
a second area demarcated from the first area;
an optical fiber installed in such a manner as to be drawn from the second area to the first area for each of the temperature-measurement targets and to pass through the temperature-measurement targets;
a temperature measurement apparatus having a light source and configured to acquire temperatures at a plurality of measurement points along an installation path of the optical fiber by detecting backscattered light generated when light emitted from the light source passes through the optical fiber; and
a signal processor configured to correct the temperatures at the measurement points acquired by the temperature measurement apparatus, wherein
the optical fiber has a reference temperature-measurement unit disposed in the second area to measure a temperature of the second area, and
when making the correction, the signal processor replaces the temperatures at the measurement points located in the second area with the temperature at the reference temperature-measurement unit.

2. The temperature measurement system according to claim 1, wherein the reference temperature-measurement unit is disposed frontward of a first one of the temperature-measurement targets and also rearward of a last one of the temperature-measurement targets along the installation path of the optical fiber.

3. The temperature measurement system according to claim 1, wherein the reference temperature-measurement unit is formed by winding a portion of the optical fiber.

4. The temperature measurement system according to claim 3, wherein a length of the optical fiber wound in the reference temperature-measurement unit is a length equal to or longer than an absolute value of a third zero point of a transfer function determined from the optical fiber and the temperature measurement apparatus.

5. The temperature measurement system according to claim 1, wherein the signal processor makes the correction using the transfer function determined from the optical fiber and the temperature measurement apparatus.

6. The temperature measurement system according to claim 5, wherein the signal processor corrects a measured temperature distribution sequentially a plurality of times in such a manner as to make smaller a square error between the measured temperature distribution and a convolution of the transfer function with a corrected temperature distribution every time the correction is made.

7. The temperature measurement system according to claim 1, wherein the temperature-measurement target is a rack housing a plurality of computers.

8. The temperature measurement system according to claim 1, wherein the second area is supplied with air having a temperature adjusted by an air conditioner.

9. The temperature measurement system according to claim 1, wherein when making the correction, the signal processor replaces temperatures at a plurality of measurement points disposed at a same site among the measurement points with an average temperature of the measurement points disposed at the same site.

10. A temperature measurement method of measuring temperatures of a plurality of temperature-measurement targets disposed in a first area, the temperature measurement method comprising:
installing an optical fiber in such a manner that the optical fiber is drawn from a second area having an adjusted temperature to the first area for each of the temperature-measurement targets and passes through the temperature-measurement targets, and disposing a portion of the optical fiber in the second area by a predetermined length and setting the portion as a reference temperature-measurement unit configured to measure a temperature of the second area; and
acquiring a measured temperature distribution by emitting light into the optical fiber, and detecting backscattered light generated in the optical fiber to detect temperatures at a plurality of measurement points along an installation path of the optical fiber; and
correcting the measured temperature distribution a plurality of times, and replacing the temperatures at the measurement points in the second area with the temperature at the reference temperature-measurement unit when the correction is made.

11. The temperature measurement method according to claim 10, wherein the reference temperature-measurement unit is disposed frontward of a first one of the temperature-measurement targets and also rearward of a last one of the temperature-measurement targets along the installation path of the optical fiber.

12. The temperature measurement method according to claim 10, wherein the reference temperature-measurement unit is formed by winding the portion of the optical fiber.

13. The temperature measurement method according to claim 10, wherein the predetermined length is a length equal to or longer than an absolute value of a third zero point of a transfer function of a temperature measurement system.

14. The temperature measurement method according to claim 10, wherein a transfer function of a temperature measurement system is used for the correction.

15. The temperature measurement method according to claim 10, wherein every time the correction is made, temperatures at a plurality of measurement points disposed at a same site among the measurement points are replaced with an average temperature of the measurement points disposed at the same site.

16. A signal processor configured to process a signal outputted from a temperature measurement apparatus connected to an optical fiber, the optical fiber being installed in such a manner as to repeatedly pass through a first area having a plurality of temperature-measurement targets disposed and a second area having an adjusted temperature, the optical fiber having a reference temperature-measurement unit configured to measure a temperature of the second area, and the temperature measurement apparatus configured to measure temperatures at a plurality of measurement points along an installation path of the optical fiber, the process comprising:
correcting a temperature distribution obtained from the temperatures of the measurement points along the installation path of the optical fiber acquired by the temperature measurement apparatus using a transfer function determined from the optical fiber and the temperature measurement apparatus; and
replacing the temperatures at the measurement points in the second area of the optical fiber with the temperature at the reference temperature-measurement unit when making the correction.
